(19) United States
(12) Patent Application Publication
(10) Pub. No.: US 2019/0278527 A1
(43) Pub. Date: Sep. 12, 2019

(54) SYSTEM AND METHOD FOR MACHINE LEARNING OPTIMIZATION OF HUMAN RESOURCE SCHEDULING FOR DEVICE REPAIR VISITS

(71) Applicants: Kabushiki Kaisha Toshiba, Minato-ku (JP); Toshiba TEC Kabushiki Kaisha, Shinagawa-ku (JP)

(72) Inventors: Michael YEUNG, Mission Viejo, CA (US); Manju SREEKUMAR, Irvine, CA (US); Milong SABANDITH, Irvine, CA (US); Methee PHOBOONME, Irvine, CA (US)

(21) Appl. No.: 15/912,844

(22) Filed: Mar. 6, 2018

(51) Int. Cl. G06F 3/12; H04N 1/00; H04N 1/32

(52) U.S. Cl. CPC G06F 3/121; H04N 1/00079; H04N 1/00037; H04N 2201/0039; H04N 1/32683; G06F 3/1287; H04N 1/00344; H04N 1/00029

(57) ABSTRACT

A system and method for multifunction peripheral device failure prediction includes a processor, memory and a network interface. The system receives device status data from each of a plurality of identified multifunction peripherals. Service history data for each of the multifunction peripherals is stored in memory. The processor detects anomalies in received device status data and generates predictive device failure data for at least one identified multifunction peripheral in accordance with detected anomalies and service history data. Predictive device failure data can be used to schedule technician visits or add device maintenance to previously scheduled visits. Such scheduling can include scheduling of service to geographically clustered devices.

### TECHNICAL FIELD

This application relates generally to maintenance of document processing devices. The application relates more particularly to predicting device failures for multifunction peripherals to facilitate prophylactic device repair and part availability.

### SUMMARY

In an example embodiment a system device failure prediction includes a processor, memory and a network interface. The system receives device status data from each of a plurality of identified multifunction peripherals. Service history data for each of the multifunction peripherals is stored in memory. The processor detects anomalies in received device status data and generates predictive device failure data for at least one identified multifunction peripheral in accordance with detected anomalies and service history data.

In accordance with another example embodiment, device failure prediction is used to generate or optimize scheduling of device servicing.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

Given the expense in obtaining and maintain MFPs, MFPs are frequently shared by users and monitored by technicians via a data network for example using Simple Network Management Protocol (SNMP). MFPs are complex devices that are subject to failures. MFP failures are frustrating for device users and work against a manufacturer's reputation. They can result in periods when a MFP is out of service, leaving users without a powerful office tool and causing user frustration when a job must wait or an alternative MFP used, such as one that is not conveniently located or one without needed capabilities that were available on the out of service MFP.

Not only are failed devices a burden on end users, they can provide significant financial cost to MFP providers. A common business model for MFPs is one wherein a distributor enters into an end user agreement where the distributer provides a device, at little or no upfront cost to the end user. User charges are based a cost per page. This cost reflects device usage charges, as well as maintenance costs. If a device fails, the end user must make a service call, and the distributor must dispatch a technician to fix the MFP. Significant human resource costs are associated with receiving a service call, logging a call, scheduling a service time, dispatching a service technician, and diagnosing and repairing the device. Such service costs can lower the distributor's profitability, increase the end user's cost per page, or both.

### BRIEF DESCRIPTION OF THE DRAWINGS

Various embodiment will become better understood with regard to the following description, appended claims and accompanying drawings wherein:

FIG. 1 is an example embodiment of a predicative device failure system;

FIG. 2 is a networked document rendering system;

FIG. 3 is an example embodiment of a digital data processing device;

FIG. 4 is a flow diagram of a device error prediction system;

FIG. 5 is a flow diagram of an example embodiment of a machine learning system;

FIG. 6 is an illustration of example machine learning algorithms;

FIG. 7 illustrates example visual depictions of machine learning algorithm results;

FIG. 8 is an example embodiment of a breakdown of device symptoms;

FIG. 9 is an example embodiment of resolutions of device failures;

FIG. 10 is a software block diagram of an example embodiment of a system for machine learning, failure prediction and service scheduling;

FIG. 11 is a graph of an example embodiment of a reactive device service schedule; and

FIG. 12 is a graph of example embodiment of a predictive device service schedule.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with an example embodiment disclosed herein, a network interface receives device status data from each of a plurality of identified multifunction peripherals. The system includes a processor and associated memory. The processor detects anomalies in received device status data, generates predictive device failure data for at least one identified multifunction peripheral in accordance with detected anomalies, generates a failure window corresponding an anticipated timing of a device failure associated with the predictive device failure data, and outputs the predictive device failure data via the network.

In accordance with a more limited example embodiment, the memory stores a device service schedule for the plurality of multifunction peripherals. The processor generates an updated device service schedule in accordance with the predictive device failure data and the failure window and output the updated device service schedule to a device service provider via the network interface.

In accordance with another more limited example embodiment, the processor generates the service schedule to include servicing a multifunction peripheral associated with a predicted failure in advance of the failure window.

In accordance with another more limited example embodiment, the processor generates the service schedule so as to balance service loads among a plurality of service technicians.

In accordance with another more limited example embodiment, the memory storesa plurality of device service procedures. The processor identifies a device service procedure corresponding to the predictive device failure, and outputs an identified device service procedure.

In accordance with another example embodiment, a system includes a plurality of multifunction peripherals. Each multifunction peripheral includes a plurality of sensors that generate state data corresponding to a state of an associated multifunction peripheral. Each multifunction peripheral further includes an intelligent controller and a network interface. The intelligent communicates generated state data to an associated server via the network interface. The server includes a server includes a network interface that receives device state data from each of the plurality of identified multifunction peripherals, a processor and associated memory. The memory stores service history data for each of the multifunction peripherals. The processor detects anomalies in received device state data. The memory also stores location data corresponding to a location of each of the plurality of multifunction peripherals. The processor generates predictive device failure data for subset of the multifunction peripherals in accordance with detected anomalies and service history data, identifies a device cluster within the subset of multifunction peripherals in accordance with the location data, and outputs the predictive device failure data and device location corresponding to identified multifunction peripherals in the device cluster.

In accordance with a more limited example embodiment, the memory also stores a maintenance schedule for the plurality of multifunction peripherals. The processor generates an updated maintenance schedule in accordance with the device cluster.

Human resource expense is the highest cost of most organizations. This is true for service orientated organization that must keep mechanical machines running to receive revenue. In general, service organizations are reactive organizations, meaning they wait until a customer calls notifying them an MFP is broken. This reactive approach creates an unpredictable schedule of how many service technicians are needed during a week or month.

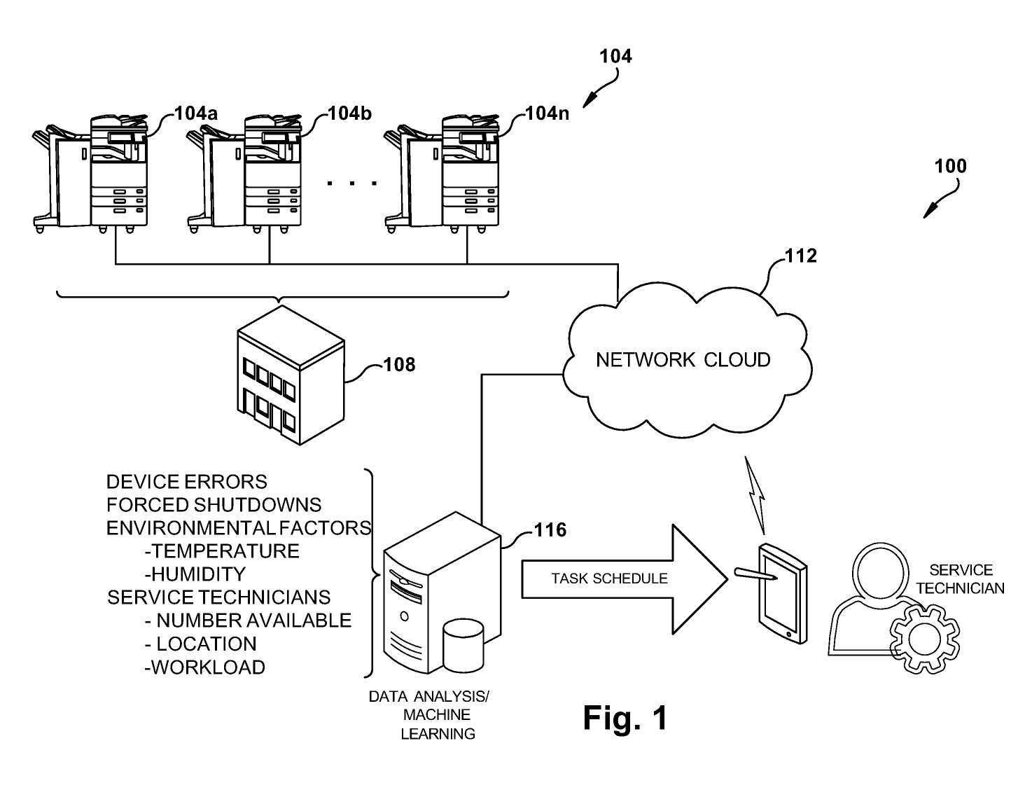

Turning to FIG. 1, illustrated is example embodiment of a predicative device failure system 1000 that includes a plurality of MFPs 104, illustrated with 104a, 104b through 104n. The MFPs 104 are dispersed geographically. One or more MFPs 104 may be located at a single business location 108, over multiple locations for a single business, or among multiple businesses. All MFPs 104 are configured for data communication via network cloud 112, suitably comprised of some or all of a local area network (LAN) or wide area network (WAN) which may comprise the global Internet. Also in data communication with network cloud 112 is a data analysis and machine learning service suitably including one or more servers as illustrated by server 116. MFPs 104 each include one or more components configured to monitor one or more states of the device which are reported to server 116 which also stores additional information such as repair histories and device maintenance schedules, suitably coordinated with one or more service technicians. Server 116 also stores location information for MFPs 104. Location information is suitably a geographic location determined for each MFP 104. Location information may be preset by a device physical location description, device installation address, device IP address information, and the like. Location information may also be determined by an MFP 104 itself, such as with GPS positioning, cell tower sector positioning, RF triangulation or the like.

Server 116 accumulates MFP data such as device error logs, device usage, such as number of print jobs or device page count, mechanical wear and tear tracking, forced shutdowns, copy interruptions or environmental factors such as temperature, humidity, ground stability, barometric pressure, and the like. Server 116 uses its available information to predict likely device failures in advance of an actual failure. Server 116 further includes information on one or more available service technicians, along with their locations and workloads. From this information, server 116 determines which technician is best suited for servicing devices, or clusters of devices. This information can be communicated to a service center or service technician via a digital device, such as tablet computer 120 of service technician 124.

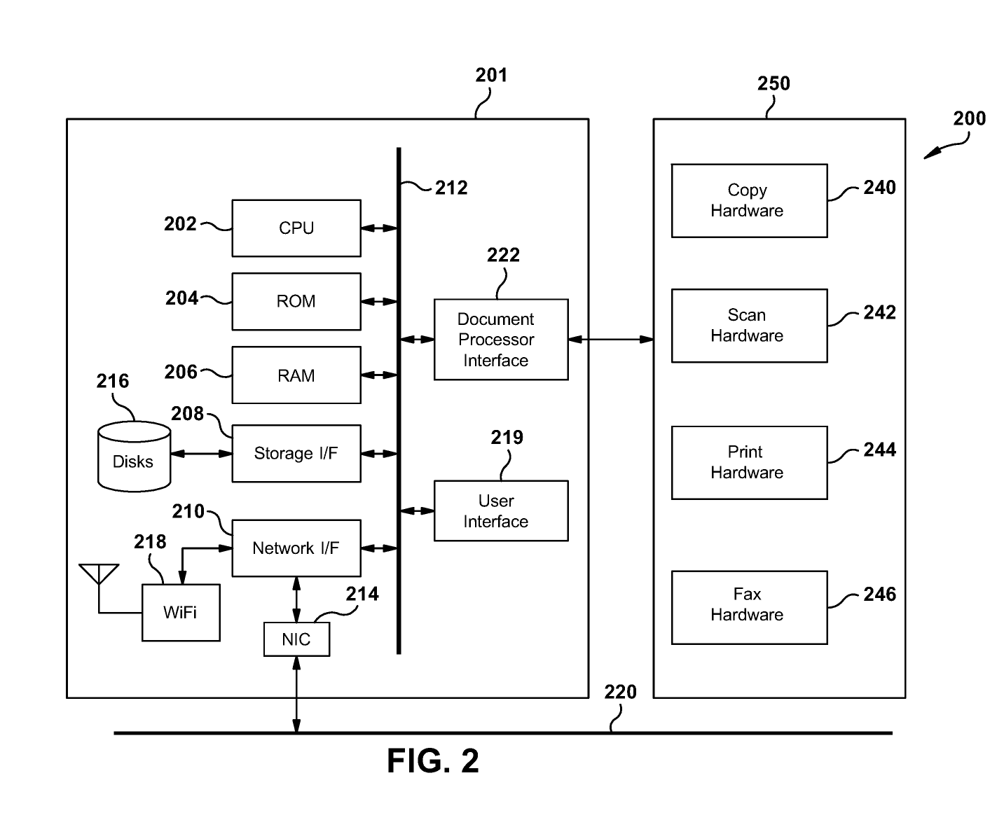

Turning now to FIG. 2 illustrated is an example embodiment of a networked digital device comprised of document rendering system 200 suitably comprised within an MFP, such as with MFPs 104 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 for interfacing with displays, keyboards, touchscreens, mice, trackballs and the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

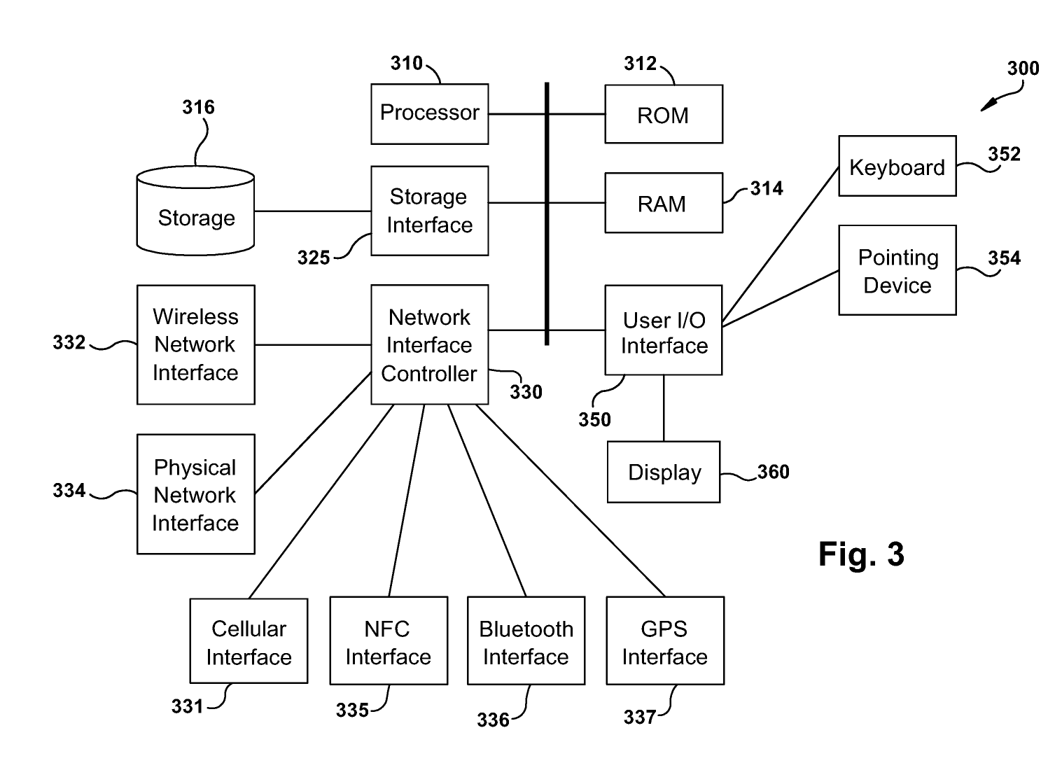

Turning now to FIG. 3, illustrated is an example embodiment of a digital data processing device 300 such as tablet computer 120 or server 116 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 331 such as when the digital device is a cell phone or tablet computer. Also included is NFC interface 335, Bluetooth interface 336 and GPS interface 337. A user input/output interface 350 suitably provides a gateway to devices such as keyboard 352, pointing device 354, and display 360, suitably comprised of a touch-screen display. It will be understood that the computational platform to realize the system as detailed further below is suitably implemented on any or all of devices as described above.

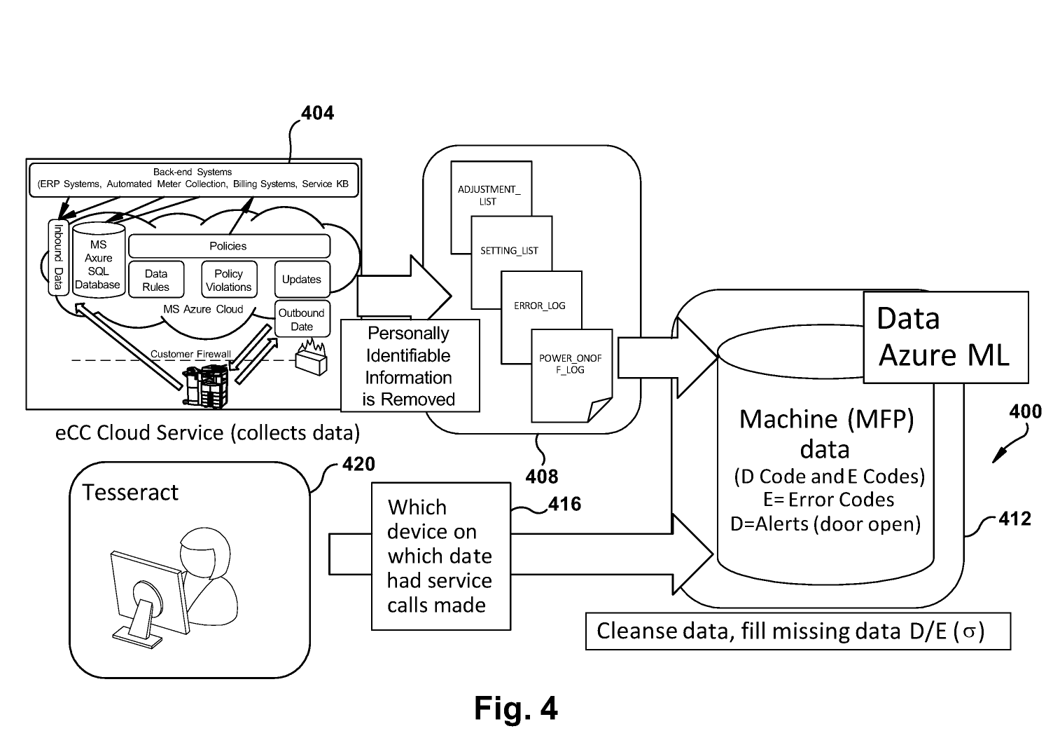

FIG. 4 is a flow diagram of a device error prediction system 400 such as one implemented in conjunction with server 116 of FIG. 1. Device monitoring is suitably accomplished with a device management system 404. By way of particular example, Toshiba TEC MFP devices are configurable and monitor able via their e-BRIDGE CloudConnect (eCC web) interface. e-BRIDGE CloudConnect is an integrated system of embedded and cloud-based applications that provide functionality to support remote monitoring and management of Toshiba MFPs. It enables management of configuration settings through automated interaction. e-BRIDGE CloudConnect gathers service information from connected MFPs, including meter data, to speed issue diagnosis and resolution.

Device management system 404 provides device state information 408 for application of machine learning and analysis for predictive device failures by a suitable machine learning platform 412 such as Microsoft Azure. Additional information 416 for such prediction, such as device service log information, is provided by a suitable CMMS (Computerized Maintenance Management System (or Software)) 420, and is sometimes referred to as Enterprise Asset Management (EAM). By way of particular example a CMMS system 420 can be based on CMMS Software, Field Service Software, or Field Force Automation Software provided by Tessaract Corporation.

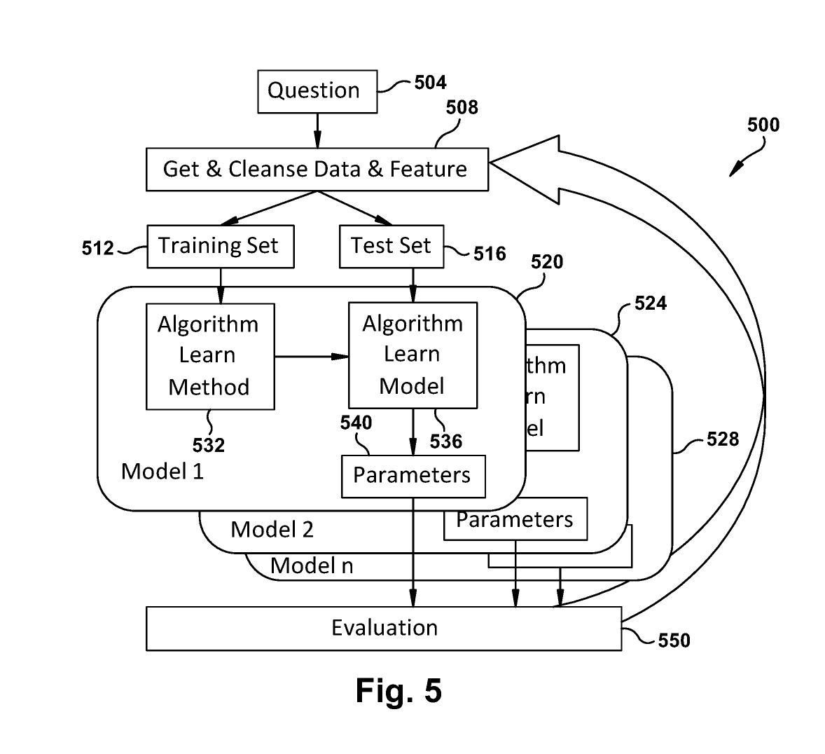

FIG. 5 illustrates a flow diagram 500 of an example embodiment of a machine learning system. In the example system, the process starts with one or more questions 504, such as when will a device likely fail and what aspects or aspects will be associated with such failure. Data is retrieved and cleansed of unneeded or problematic data at 508 and this data is provided for both training 512 and testing 516. These results are provided to a machine learning system, suitably comprised of one or more learning models such as models 520, 524 and 528. Each learning model 520, 524, 528 includes one or more algorithm learn methods, such as algorithm learn methods 532 and 536 of model 520. Parameters, such as parameters 540 of model 520, are provided for evaluation at 550, and results are fed back to data acquisition at 508 for iterative calculation.

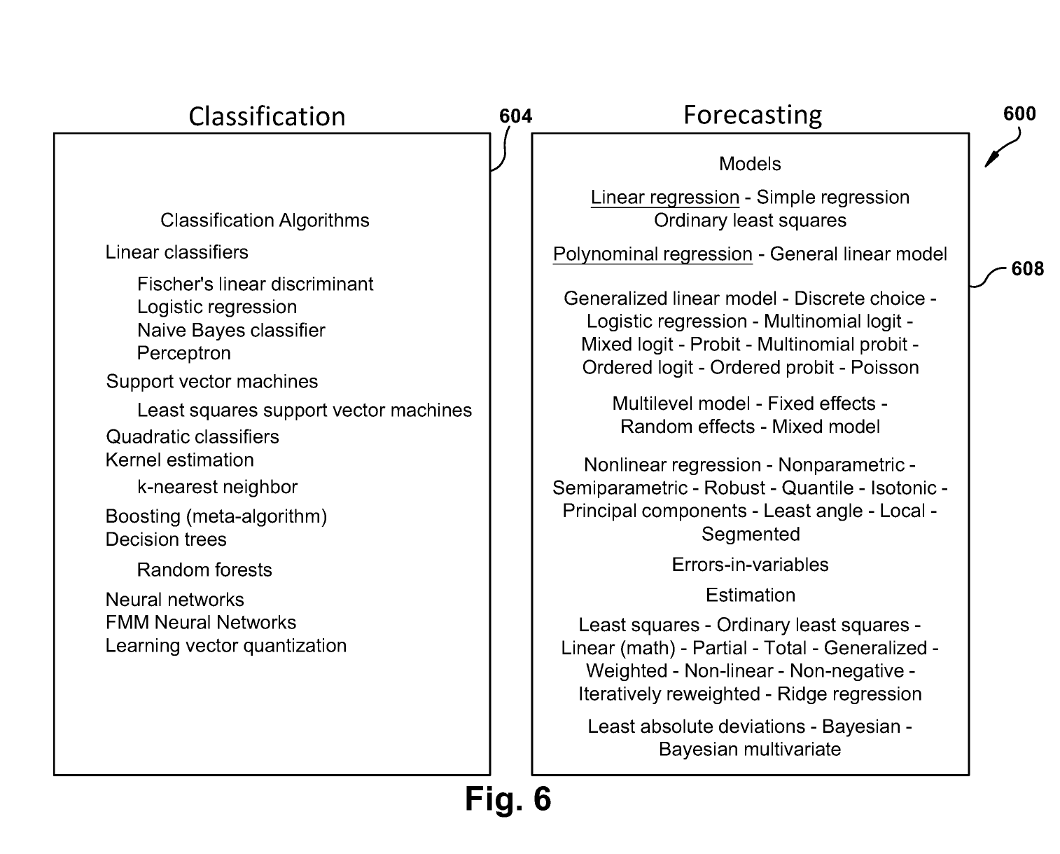

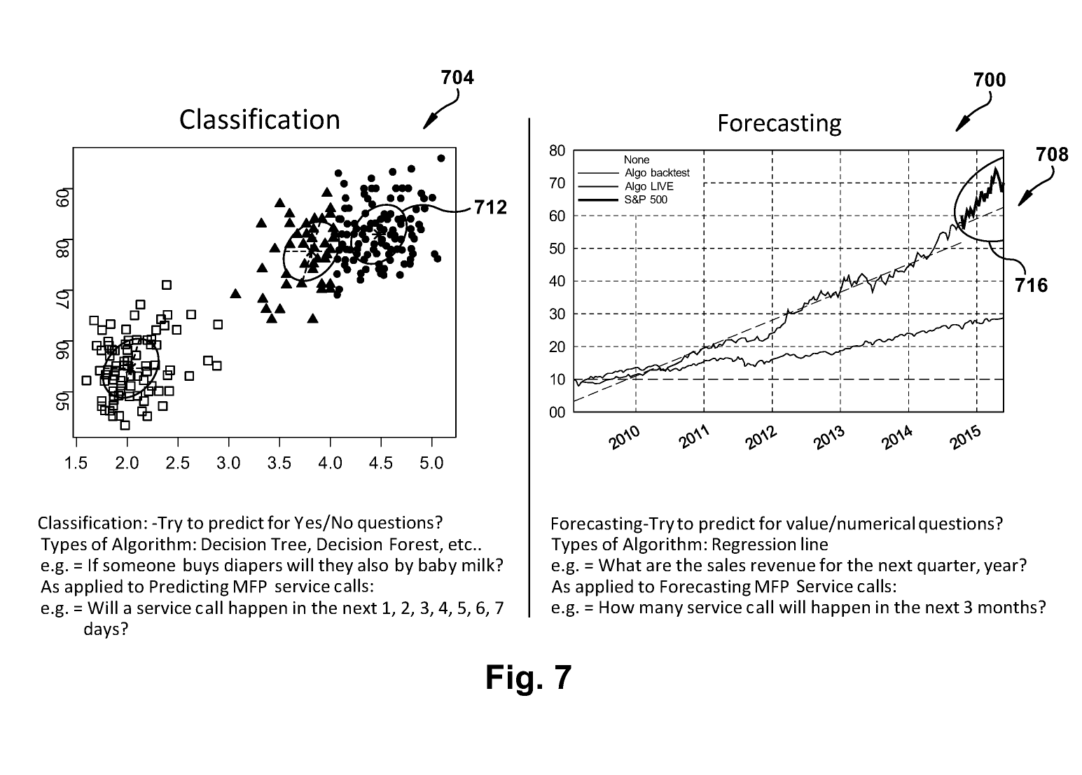

FIG. 6 provides example machine learning algorithms 600 including classification algorithms 604 and forecasting algorithms 608. FIG. 7 provides example visual depictions of algorithm results 700, including classification results 704 and forecasting results 708. Device clusters, such as cluster 712, may be indicative of device error conditions with corresponding failure forecasting with results 716. Once the classification algorithms 604 and forecasting algorithms 608 are trained, they can detect anomalies in the received status data from MFPs to generate predictive device failure data and use service history data to generate service schedules.

A database anomaly is a flaw in database. Human error can generate anomalies which occurs because of poor planning and storing everything in a flat database. Anomalies can be removed by the process of normalization which is suitably performed by splitting/joining of tables.

There are three types of database anomalies:
a) Insertion anomaly: This occurs when one is not able to insert certain attribute in the database without the presence of another attribute.
b) Update anomaly: This occurs in case of data redundancy and partial update. In other words a corrected database needs other actions such as addition, deletion or both.
c) Deletion Anomaly: This occurs where deletion some data is deleted because of deletion of some other data.

By way of particular example, a determination of likeliness of a forthcoming service call can be utilized to schedule device maintenance. Such scheduling is suitably integrated with service calls already scheduled or with servicing of two or more geographically proximate devices to minimize travel time needed for technician on-site visits. Suitable machine learning systems are built on available third party platforms such as R-Script, Microsoft Azure, Google Next, Kaggle.com or the like.

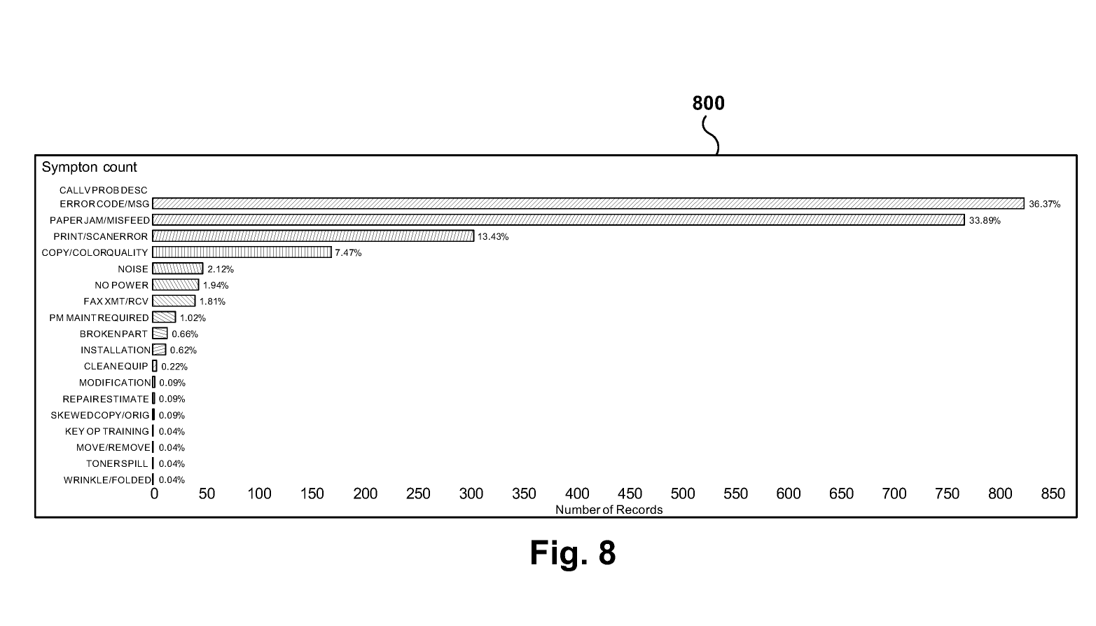

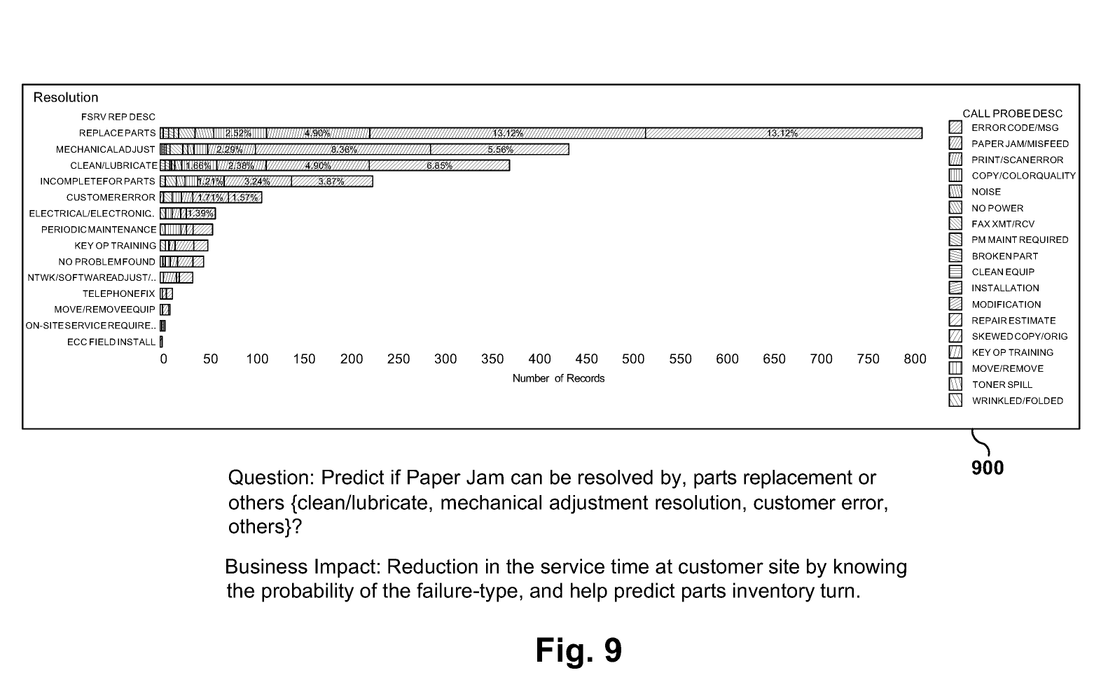

FIG. 8 is an example embodiment of breakdown of device symptoms 800 for determination of service call likelihood. FIG. 9 is an example embodiment of problem resolutions 900 associated with device error conditions. Resolutions 900 can be ranked and presented as potential resolution options for preventative service calls.

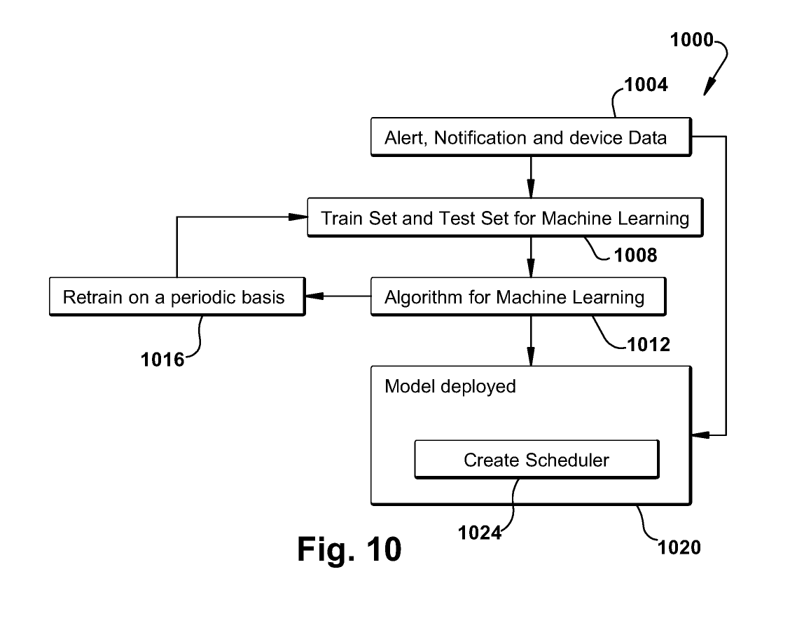

FIG. 10 is a software block diagram 1000 an example embodiment of a system for machine learning, failure prediction and service scheduling. Alert, notification and device data is obtained at block 1004, and a training set and test set for machine learning formed at block 1008. A machine learning algorithm is operated at block 1012 with periodic retraining occurring at block 1016 to update training and test sets at block 1008. Algorithm application at block 1012 generates model deployment at block 1020 schedule creation at block 1024.

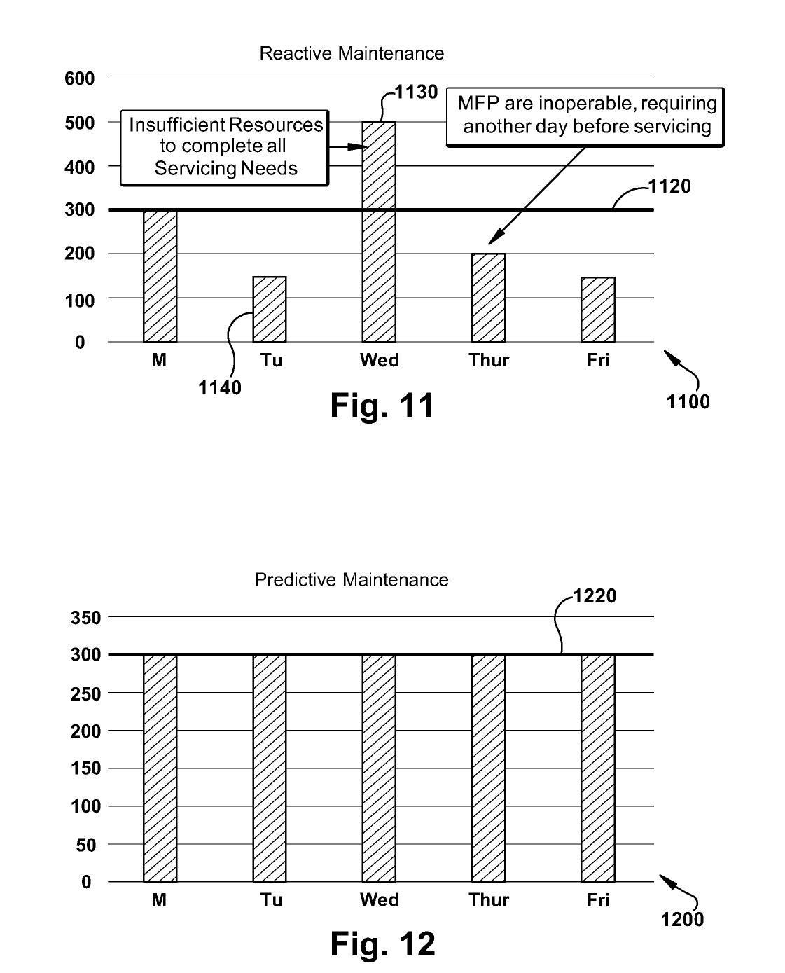

FIG. 11 illustrates a graph of an example servicing schedule 1100 with vertical bars defining a number of devices which need to be serviced on a given day. Line 1120 illustrates resources available for servicing on each day. Resources may include labor hours available parts available, or both. Bar 1130 illustrates a day wherein too many devices need to be serviced relative to available resources. Bar 1140 illustrates a day wherein a number of jobs to be serviced is well under resources that are available that day. In the example, incomplete jobs on Wednesday would be carried to Thursday, which, in turn, delays Thursday jobs, and so forth. A service technician would have to commute once again to the location of the jobs on Wednesday to complete them a day late, with the accumulating commute time further adding to cascading delays.

FIG. 12 illustrates a graph of an example servicing schedule 1200 with predictive maintenance scheduling implemented. It will be noted that jobs fit within available resources, line 1220, each day rendering a substantially more efficient servicing schedule.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a network interface configured to receive device status data from each of a plurality of identified multifunction peripherals; and
a processor and associated memory,
the processor configured to detect anomalies in received device status data,
the processor further configured generate predictive device failure data for at least one identified multifunction peripheral in accordance with detected anomalies,
the processor further configured to generate a failure window corresponding an anticipated timing of a device failure associated with the predictive device failure data, and
the processor further configured to generate required resource data corresponding to resources required to address the device failure, and
the processor further configured to output the predictive device failure data via the network and required resource data.

2. The system of claim 1 wherein the memory is configured to store a device service schedule for the plurality of multifunction peripherals,
wherein the processor is further configured to generate an updated device service schedule in accordance with the predictive device failure data, required resource data, and the failure window, and
wherein the processor is further configured to output the updated device service schedule to a device service provider via the network interface.

3. The system of claim 2 wherein the processor is further configured to generate the service schedule to include servicing a multifunction peripheral associated with a predicted failure in advance of the failure window.

4. The system of claim 3 wherein the processor is further configured to generate the service schedule so as to balance service loads among a plurality of service technicians.

5. The system of claim 1 wherein the processor is further configured to output at least one proposed resolution corresponding to the predictive device failure data.

6. The system of claim 5 wherein the processor is further configured to output the proposed resolution as a device repair for the identified multifunction peripheral.

7. The system of claim 3 wherein the processor is further configured to output at least one proposed resolution corresponding to the predictive device failure data as a preventative maintenance service on the identified multifunction peripheral.

8. The system of claim 1 wherein the memory is configured to store a plurality of device service procedures,
wherein the processor is further configured to identify a device service procedure corresponding to the predictive device failure, and
wherein the processor is further configured to output an identified device service procedure.

9. A method comprising:
receiving, into a digital processing device that includes a processor and associated memory, device status data from each of a plurality of identified multifunction peripherals;
detecting, by the processor, anomalies in received device status data;
generating, by the processor, predictive device failure data for at least one identified multifunction peripheral in accordance with the detected anomalies;
generating, by the processor, a failure window corresponding an anticipated timing of a device failure associated with the predictive device failure data; and
generating required resource data corresponding to resources required to address the device failure; and
outputting, by the processor, the predictive device failure data via an associated network and the required resource data.

10. The method of claim 9 further comprising:
storing a device service schedule for the plurality of multifunction peripherals;
generating an updated device service schedule in accordance with the predictive device failure data, the required resource data and the failure window; and
outputting the updated device service schedule to a device service provider via the network interface.

11. The method of claim 10 further comprising generating the service schedule to include servicing a multifunction peripheral associated with a predicted failure in advance of the failure window.

12. The method of claim 11 further comprising generating the service schedule so as to balance service loads among a plurality of service technicians.

13. The method of claim 9 further comprising outputting at least one proposed resolution corresponding to the predictive device failure data.

14. The method of claim 13 further comprising outputting the proposed resolution as a device repair for the identified multifunction peripheral.

15. The method of claim 11 further comprising outputting at least one proposed resolution corresponding to the predictive device failure data as a preventative maintenance service on the identified multifunction peripheral.

16. The method of claim 9 further comprising:
storing a plurality of device service procedures;
identifying a device service procedure corresponding to the predictive device failure; and
outputting an identified device service procedure.

17. The method of claim 9 wherein the device state data includes multifunction peripheral device errors and device usage data.

18. The method of claim 15 further comprising:
storing a plurality of device service procedures;
identifying a device service procedure corresponding to the predictive device failure; and
outputting an identified device service procedure.

19. A system comprising:
a plurality of multifunction peripherals, each multifunction peripheral including,
a plurality of sensors configured to generate state data corresponding to a state of an associated multifunction peripheral,
an intelligent controller, and
a network interface, wherein
the intelligent controller configured to communicate generated state data to an associated server via the network interface; and
a server including,
a network interface configured to receive device state data from each of the plurality of identified multifunction peripherals, and
a processor and associated memory,
the memory configured to store service history data for each of the multifunction peripherals,
the processor configured to detect anomalies in received device state data,
the memory further configured to store location data corresponding to a location of each of the plurality of multifunction peripherals,
the processor further configured generate predictive device failure data for subset of the multifunction peripherals in accordance with detected anomalies and service history data,
the processor further configured to generate required resource data corresponding to resource usage associated with generated predicative device failure data,
the processor further configured to identify a device cluster within the subset of multifunction peripherals in accordance with the location data, and
the processor further configured to output the predictive device failure data and device location corresponding to identified multifunction peripherals in the device cluster.

20. The system of claim 19 wherein the memory is further configured to store a maintenance schedule for the plurality of multifunction peripherals, and
wherein the processor is further configured to generate an updated maintenance schedule in accordance with the device cluster.
